(19) United States
(12) Patent Application Publication
(10) Pub. No.: US 2018/0180280 A1
(43) Pub. Date: Jun. 28, 2018

(54) SYSTEM AND METHOD FOR COMBUSTION SYSTEM CONTROL

(71) Applicant: GENERAL ELECTRIC TECHNOLOGY GMBH, Baden (CH)

(72) Inventors: CARL NEUSCHAEFER, ENFIELD, CT (US); CARL BOZZUTO, ENFIELD, CT (US); JOSEPH QUINN, BLOOMFIELD, CT (US)

(73) Assignee: GENERAL ELECTRIC TECHNOLOGY GMBH, BADEN (CH)

(21) Appl. No.: 15/391,094

(22) Filed: Dec. 27, 2016

(51) Int. Cl. F23C 5/00; F01D 15/10; F23L 7/00

(52) U.S. Cl. CPC F23C 5/00; F01D 15/10; F23C 2200/00; F05D 2220/31; F23L 7/007

(57) ABSTRACT

A combustion system includes a combustion chamber, a plurality of fuel introduction locations in the combustion chamber where fuel and air are provided to the combustion chamber for combustion, a fluid flow control device associated with each fuel introduction location, each fluid flow control device being controllable to vary an amount of the air supplied to each fuel introduction location, a plurality of sensing devices configured to monitor a plurality of operational parameters of the combustion system, and a control unit configured to control each fluid flow control device to control the amount of air supplied at each fuel introduction location independent of the amount of air supplied at the other fuel introduction locations, and to control the amount of air provided to all other air introduction locations, in dependence upon at least one of the plurality of operational parameters to minimize excess air provided to the combustion chamber.

### BACKGROUND

### Technical Field

Embodiments of the invention relate generally to combustion systems and, more particularly, to a system and method for optimizing the control and performance of a combustion system for boilers, furnaces and fired heaters.

### Discussion of Art

A boiler typically includes a furnace in which fuel is burned to generate heat to produce steam. The combustion of the fuel creates thermal energy or heat, which is used to heat and vaporize a liquid, such as water, which makes steam. The generated steam may be used to drive a turbine to generate electricity or to provide heat for other purposes. Fossil fuels, such as pulverized coal, are typical fuels used in many combustion systems for boilers. For example, in an air-fired pulverized coal boiler, atmospheric air is fed into the furnace and mixed with the pulverized coal for combustion. In an oxy-fired pulverized coal boiler, concentrated levels of oxygen are fed into the furnace and mixed with pulverized coal for combustion.

As is known in the art, proper mixing of the fuel and air as it is introduced to the nozzle or burner for combustion is essential for efficient and clean operation of combustion systems. Under perfect combustion conditions and ideal mixing conditions it is theoretically possible to react all of the fuel with zero percent excess air. The ideal ratio of air/oxygen to fuel that burns all fuel with no excess air is referred to as the stoichiometric ratio. In practice, however, perfect mixing and temperature conditions are never achieved, necessitating the use of a certain amount of excess air to ensure complete combustion of the fuel. In particular, if excess air is not added to the combustion process, unburned carbon, soot, smoke, and carbon monoxide exhaust can create additional emissions and heat transfer surface fouling. From a safety standpoint, properly controlling excess air reduces flame instability and other hazards. Existing combustion systems may use upwards of 20-30% excess air to ensure reliable operation with a wide range of fired fuels and across all potential load and firing conditions.

Even though excess air is needed from a practical standpoint, however, too much excess air can lower boiler efficiency. Thus, a balance must be found between providing the optimal amount of excess air to achieve ideal combustion and prevent combustion issues associated with too little excess air, while not providing too much excess air that reduces efficiency and increases NOₓ emissions.

In view of the above, there is a need for a system and method for controlling a combustion system for a boiler that continually seeks the lowest possible excess air conditions to maximize efficiency, while maintaining optimum main burner zone stoichiometry to minimize emissions and while honoring a multitude of real-time operating process constraints required to preserve operation and safety.

### BRIEF DESCRIPTION

In an embodiment, a combustion system is provided. The combustion system includes a combustion chamber, a plurality of fuel introduction locations in the combustion chamber where fuel and air are provided to the combustion chamber for combustion, a fluid flow control device associated with each fuel introduction location, each fluid flow control device being controllable to vary an amount of the air supplied to each fuel introduction location, a plurality of sensing devices configured to monitor a plurality of operational parameters of the combustion system, and a control unit configured to control each fluid flow control device to control the amount of air supplied at each fuel introduction location independent of the amount of air supplied at the other fuel introduction locations, and to control the amount of air provided to all other air introduction locations, in dependence upon at least one of the plurality of operational parameters to minimize excess air provided to the combustion chamber.

In another embodiment, a method of controlling a combustion system is provided. The method includes the steps of introducing fuel and air to a combustion chamber at a plurality of fuel introduction locations, monitoring a plurality of operational parameters of the combustion system, and minimizing an amount of excess air provided to the combustion chamber by individually controlling an amount of air supplied to the combustion chamber at each of the fuel introduction locations in dependence upon at least one of the plurality of operational parameters.

In yet another embodiment, a boiler is provided. The boiler includes a combustion chamber, a plurality of fuel introduction locations in the combustion chamber for introducing fuel to the combustion chamber for combustion, a plurality of fluid flow control devices, each fluid flow control device being controllable to vary an amount of air supplied to the boiler, a plurality of sensing devices configured to monitor a plurality of operational parameters of the combustion system, and a control unit configured to control the amount of the air supplied to the boiler in dependence upon at least one of the plurality of operational parameters to continuously optimize an amount of excess air provided to the combustion chamber.

### DRAWINGS

The present invention will be better understood from reading the following description of non-limiting embodiments, with reference to the attached drawings, wherein below:

FIG. 1 is a simplified schematic illustration of a combustion system according to an embodiment of the invention.

FIG. 2 is a schematic illustration of a tangentially-fired boiler of the combustion system of FIG. 1, according to an embodiment of the invention.

FIG. 3 is a schematic illustration of a control routine for a controller of the combustion system of FIG. 1.

FIG. 4 is a chart illustrating a hierarchal control executed by the controller, according to an embodiment of the invention.

### DETAILED DESCRIPTION

Reference will be made below in detail to exemplary embodiments of the invention, examples of which are illustrated in the accompanying drawings. Wherever possible, the same reference characters used throughout the drawings refer to the same or like parts. While embodiments of the invention are suitable for use with combustion systems, generally, a pulverized coal boiler such as for use in a pulverized coal power plant has been selected for clarity of illustration. Other combustion systems may include other types of boilers, furnaces and fired heaters utilizing a wide range of fuels including, but not limited to, coal, oil and gas. For example, contemplated boilers include, but are not limited to, may both T-fired and wall fired pulverized coal boilers, circulating fluidized bed (CFB) and bubbling fluidized bed (BFB) boilers, stoker boilers, suspension burners for biomass boilers, dutch oven boilers, hybrid suspension grate boilers, and fire tube boilers. In addition, other combustion systems may include, but are not limited to, kiln, incinerator, fired heater and glass furnace combustion systems.

As used herein, “electrical communication” or “electrically coupled” means that certain components are configured to communicate with one another through direct or indirect signaling by way of direct or indirect electrical connections. As used herein, “mechanically coupled” refers to any coupling method capable of supporting the necessary forces for transmitting torque between components. As used herein, “operatively coupled” refers to a connection, which may be direct or indirect. The connection is not necessarily being a mechanical attachment.

Embodiments of the invention relate to a combustion system and method and control scheme therefor that continually seeks the lowest possible excess air conditions to maximize system efficiency, while at the same time maintaining optimum main burner zone stoichiometry to minimize emissions and honoring a multitude of real-time operating process constraints require to preserve operation and safety. The combustion system includes a combustion chamber, a plurality of fuel introduction locations in the combustion chamber where fuel and air are provided to the combustion chamber for combustion, a fluid flow control device associated with each fuel introduction location, each fluid flow control device being controllable to vary an amount of the air supplied to each fuel introduction location, a plurality of sensing devices configured to monitor a plurality of operational parameters of the combustion system, and a control unit configured to individually control the amount of the air supplied to each of the fuel introduction locations in dependence upon at least one of the plurality of operational parameters to minimize excess air provided to the combustion chamber. In particular, the control unit is configured to individually control the amount of air provided to each air introduction location to continuously optimize the level excess air for the combustion process in real-time on a continuous operating basis.

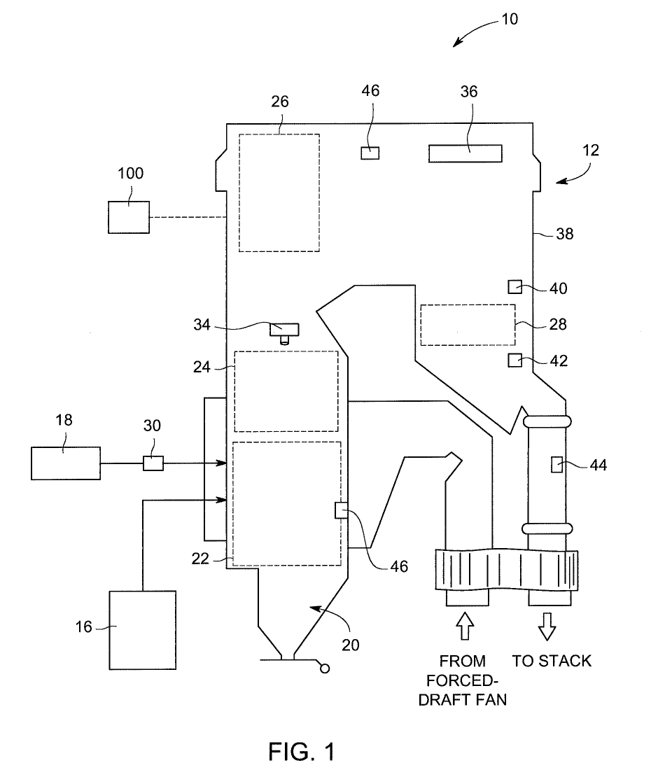

FIG. 1 illustrates a combustion system 10 having a boiler 12. The boiler 12 may be a tangentially fired boiler (also known as a T-fired boiler) or wall fired boiler. T-firing is different from wall firing in that it utilizes burner assemblies with fuel admission compartments located at the corners of the boiler furnace, which generates a rotating fireball that fills most of the furnace cross-section. Wall firing, on the other hand, utilizes burner assemblies that are perpendicular to a side of the boiler.

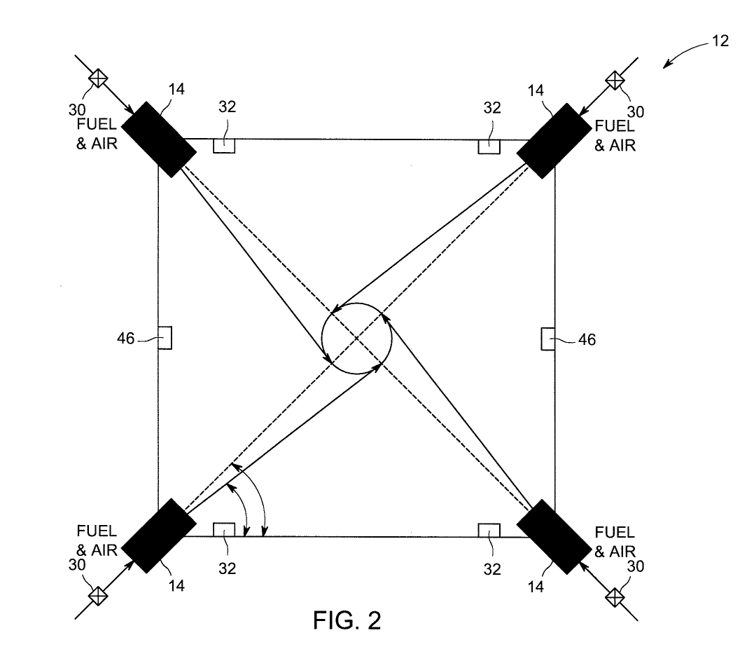

FIG. 2 depicts a tangentially fired boiler 12. Tangentially fired boilers have a rectangular cross-section and have burner assemblies 14 defining fuel introduction locations positioned at the corners. Fuel and air are introduced into the boiler 12 via the burner assemblies 14 and/or nozzles associated therewith, and are directed tangentially to an imaginary circle located at the center of the furnace and with a diameter greater than zero. This generates a rotating fireball that fills most of the furnace cross-section. The fuel and air mixing is limited until the streams join together in the furnace volume and generate a rotation.

With further reference to FIG. 1, the combustion system 10 includes a fuel source such as, for example, a pulverizer 16 that is configured to grind fuel such as coal to a desired degree of fineness. The pulverized coal is passed from the pulverizer 16 to the boiler 12. An air source 18 provides a supply of primary or combustion air to the boiler 12 where it is mixed with the fuel and combusted, as discussed in detail hereinafter. Where the boiler 12 is an oxy-fired boiler, the air source 18 may be an air separation unit that extracts oxygen from an incoming air stream, or directly from the atmosphere.

As shown in FIG. 1, the boiler 12 includes a hopper zone 20 located below a main burner zone 22 from which ash can be removed, the main burner zone 22 (also referred to as a windbox) where the air and an air-fuel mixture is introduced into the boiler 12, a burnout zone 24 where any air or fuel that is not combusted in the main burner zone 22 gets combusted, a superheater zone 26 where steam can be superheated to drive a turbine to generate electricity, for example, and an economizer zone 28 where water can be preheated prior to entering a steam drum or a mixing sphere (not shown). Combustion of the fuel with the primary air within the boiler 12 produces a stream of flue gases that are ultimately treated and exhausted through a stack downstream from the economizer zone 28. As used herein, directions such as “downstream” means in the general direction of the flue gas flow. Similarly, the term “upstream” is opposite the direction of “downstream” going opposite the direction of flue gas flow.

As illustrated in FIGS. 1 and 2, the combustion system 10 includes an array of sensors, actuators and monitoring devices to monitor and control the combustion process and the resulting consequences with respect to low excess air operation, as discussed in detail hereinafter. For example, the combustion system 10 may include a plurality of fluid flow control devices 30 associated with the conduit that supplies primary air for combustion to each fuel introduction nozzle associated with the burner assemblies 14. In an embodiment, the fluid flow control devices 30 may be electrically actuated air dampers that can be adjusted to vary the amount of air that is provided to each fuel introduction nozzle associated with each burner assembly 14. As shown in FIG. 2, each corner of the boiler 12 includes a respective fluid flow control device 30 associated with each fuel introduction nozzle of each burner assembly 14. The boiler 12 may also include other individually controllable air dampers or fluid flow control devices (not shown) at various spatial locations around the furnace. Each of the flow control devices 30 is individually controllable by a combustion control unit 100 to ensure that desired air/fuel ratios and flame temperature are achieved for each nozzle location.

The combustion system 10 may also include a flame scanning device 32 associated with each individual fuel introduction nozzle or burner assembly 14. The flame scanning devices 32 are configured to assess the local stoichiometry (air/fuel ratio) at each respective the nozzle location within the main burner zone 22. In addition to detecting the respective quantities of air and fuel at each nozzle location, the flame scanning devices 32 are also configured to sense the flame temperature adjacent to each burner assembly 14. The flame scanning device 32 are electrically connected or otherwise communicatively coupled to the combustion control unit for communicating the measured stoichiometric parameters and detected temperatures to the control unit 100 for use in controlling the combustion process, as discussed in detail hereinafter. In an embodiment, the flame scanning devices 32 may instead be a single flame scanner that is configured to individually monitor and detect the local stoichiometry and temperature at each nozzle location.

With further reference to FIG. 1 the combustion system 10 may also include a flame stability monitor 34 located, for example, just above the burnout zone 24. The flame stability monitor 34 may likewise be electrically or communicatively coupled to the control unit 100 and is configured to measure or otherwise assess fireball stability within the boiler 12. The flame stability monitor 34 provides feedback to enable determination of combustion stability, which is used for low excess air control and to achieve low load turndown operation, as discussed hereinafter. In addition, a 2D optical flame scanner 46 may also be positioned in the upper furnace for monitoring and assessing flame characteristics (e.g., temperature).

In an embodiment, the system 10 may further include a temperature mapping device 36 such as, for example, a 2D acoustic temperature mapping device for mapping a flue gas temperature at a cross-section of the backpass 38 of the boiler 12.

FIG. 1 also illustrates that the backpass 38 of the boiler 12 downstream from the temperature mapping device 36 and upstream from the economizer section 28 is fitted with a monitoring device 40. In an embodiment, the monitoring device 40 is a laser-based monitoring device such as, for example, a tunable diode laser flue-gas monitoring device. The monitoring device 40 may include one or more optical sources that may, for example, pass through a portion of a flue gas duct defined by the backpass 38. The optical sources provide optical beams that pass through the flue gasses within the backpass 38 and are detected by a corresponding plurality of detectors (not shown). As the beams pass through the flue gasses, there is absorption of various wavelengths characteristic of the constituents within the flue gasses. The optical sources are coupled to a processor to provide for characterization of received optical signals and identify the constituents, their concentrations and other physical properties or parameters of substances in the flue gasses. In other embodiments, such analysis may be performed internally by the combustion control unit 100.

In an embodiment, the monitoring device 40 is configured for measurement and assessment of gas species such as carbon monoxide (CO), carbon dioxide (CO₂), mercury (Hg), sulfur dioxide (SO₂), sulfur trioxide (SO₃), nitrogen dioxide (NO₂), nitric oxide (NO) and oxygen (O₂) within the backpass 38. SO₂ and SO₃ are collectively referred to as SOx. Similarly, NO₂ and NO are collectively referred to as NOx.

Downstream from the economizer section 28, the combustion system 10 may further include a device or sensor 42 for measuring the amount of unburnt carbon in the fly ash within the backpass 38. The device 42, like monitoring device 40, may be a laser-based detection device, although other types of devices capable of detecting the amount of carbon in the fly ash may also be utilized without departing from the broader aspects of the invention. The device 42 may likewise be electrically or communicatively coupled to the control unit 100 for transmitting data indicating the measured amount of unburnt carbon thereto.

As also, shown in FIG. 1, a sensor 44 arranged within the outlet to the stack may be utilized to monitor the concentration of oxygen within the flue gas. In an embodiment, the sensor 44 may be a paramagnetic sensor. The sensor 44 may be communicatively coupled to the control unit 100 for relaying the detected oxygen concentration to the control unit 100. While the array of sensors and monitoring devices discussed herein may be utilized to detect, for example, carbon monoxide and other emissions, oxygen distribution, carbon in fly ash, fireball stability and the like, various other sensors and monitoring devices may also be utilized to measure pressure drop between various locations within the boiler 12, temperature at various locations within the boiler, heat flux and furnace wall conditions. For example, in an embodiment, the stack may be configured with an opacity monitor to assess the degree to which visibility of a background (i.e., blue sky) is reduced by particulates for use in determining the amount or concentration of particulates within the flue gases exiting the stack. In addition, as shown in FIG. 1, the boiler 12 may include one or more furnace wall condition sensors 46 for assessing heat flux, corrosion of the furnace walls and/or deposit buildup.

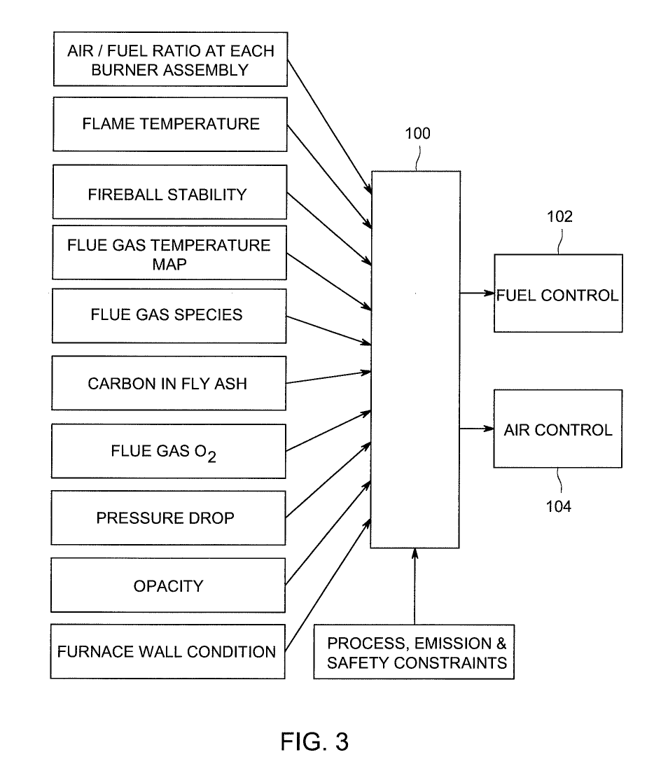

In operation, a predetermined ratio of fuel and air is provided to each of the burner assemblies 14 for combustion. As the fuel/air mixture is combusted within the furnace and flue gases are generated, the combustion process and flue gases are monitored. In particular, as discussed above and as illustrated in FIG. 3, various parameters of the fireball and flame, conditions on the walls of the furnace, and various parameters of the flue gas are sensed and monitored. These parameters are transmitted or otherwise communicated to the combustion control unit 100 where they are analyzed and processed according to a control algorithm stored in memory and executed by a processor.

The control unit 100 is configured to control the fuel provided to the boiler 12 and/or the air provided to the boiler 12, as shown at 102 and 104, respectively, in dependence upon the one or more monitored combustion and flue gas parameters and furnace wall conditions. As used herein, the monitored parameters and conditions are collectively referred to as “operational parameters” of the boiler. For example, in an embodiment, the control unit 100 is configured to control the fluid flow control devices 30 associated with each burner assembly 14 and/or the other damper devices surrounding the main burner zone 22, hopper zone 20 and burnout zone 24 of the boiler 12 to continuously attempt to reduce excess air provided to the boiler 12 to maximize efficiency, while maintaining emissions below prescribed threshold levels (and avoid other undesirable consequences that might result from any low excess air combustion conditions) and while maintaining operational performance above threshold levels. In particular, the control unit 100 is configured to control the damper devices 12 to minimize the amount of excess air provided to the boiler 12 and control main burner zone local stoichiometries associated with each individual fuel nozzle associated with each burner assembly 14 (i.e., assure that the desired air/fuel ratios are achieved for each and all nozzle locations). In this manner, the overall excess air level can be reduced to its optimum plant heat rate level without causing other issues for the equipment, process or environment, such as high CO emissions, high unburned carbon in fly ash, high opacity, high pressure drop, etc. In connection with the above, the control unit 100 is further configured to provide simultaneous control of the air at each fuel location to balance the air/fuel ratio based on the unique parameter measurements.

The operational and control approach described herein is based on a plurality of sensor-driven feedbacks and a model-based combustion control unit 100. As discussed above, the combustion control unit 100 drives the process actuators to find the to find the lowest excess air operating conditions possible given the particular fuel utilized and other measured process conditions, e.g., unburned carbon in fly ash, furnace exit temperatures, emission profiles, corrosion rates, etc.

In an embodiment, the operational parameters may include, but are not limited to, carbon monoxide content in the flue gas, carbon in fly ash, on-line coal properties, coal flow balance, oxygen content in the backpass, gas species in the flue gas, furnace temperature, air heater basket condition, fouling of the hanging section, coal contact moisture, as well as other feedbacks from various sensors and monitoring devices such as the main burner zone flam scanner, flame stability sensor, mill sensors, a main burner zone waterwall corrosion advisor, soot blower advisor, a fly ash resistivity sensor, a primary air and forced draft fan health monitor, sulfur dioxide dew point sensor, an on-mill health monitor, a tube outside diameter corrosion probe, a waterwall tube leak sensor, and a mill and air heater fire detector.

In an embodiment, at a first level of control, the control unit 100 is configured to precisely control the air/fuel ratio at each fuel nozzle in dependence upon measurement signals from the optical flame scanners 32 associated with each nozzle/burner assembly 14. In particular, the flame scanners 32 are configured to measure the fuel/air ratio at each fuel nozzle 14 and provide this information to the control unit 100. The control unit 100 is then configured to adjust the individual dampers 30 associated with each fuel nozzle to bring the air/fuel ratios at each fuel nozzle into agreement with each other (i.e., so that they are all the same).

At a second level of control, the control unit 100 may then adjust the individual dampers 30 associated with each local fuel nozzle/burner assembly 14 (e.g., at each T-fired boiler elevation), as well as the other damper assemblies of the boiler 12 to optimize (minimize) excess air within the main burner zone 22 and maximize boiler efficiency. At this second level of control, while adjusting the amount of air at each burner assembly 14 and at other spatial locations of the boiler 12, the control unit 100 simultaneously utilizes the sensor inputs and sensor constrains to ensure that emissions and other operational constraints or thresholds are not exceeded.

For example, if, upon decreasing the amount of excess air provided to the main burner zone 22, the amount of unburnt carbon detected in the fly ash by sensor 42 exceeds a threshold stored in memory, this may indicate to the control unit 100 that excess air has been decreased excessively (indicating that all of the fuel provided to the main burner zone 22 is not being combusted). The control unit 100 may then increase the excess air through flow control device 30 and subsequently readjust the air/fuel ratio at each nozzle 14 through control of the individual air dampers 30 until the amount of unburnt carbon detected is brought within acceptable levels.

Likewise, if, upon decreasing the amount of excess air provided to the main burner zone 22 in an effort to increase boiler efficiency, carbon monoxide emissions exceed threshold levels, this may signal that not enough air is present to combust all of the fuel. The control unit 100 may then increase the excess air as described above through control of the individual air dampers 30 until carbon monoxide measurements are brought within acceptable levels. This control routine can be implemented based upon other sensor feedbacks, or a plurality of sensor feedbacks. In this manner, the plurality of sensors and measurement signals provided to the control unit 100 enable the real-time control of the combustion process (including the real-time control of excess air in dependence upon a plurality of monitored parameters).

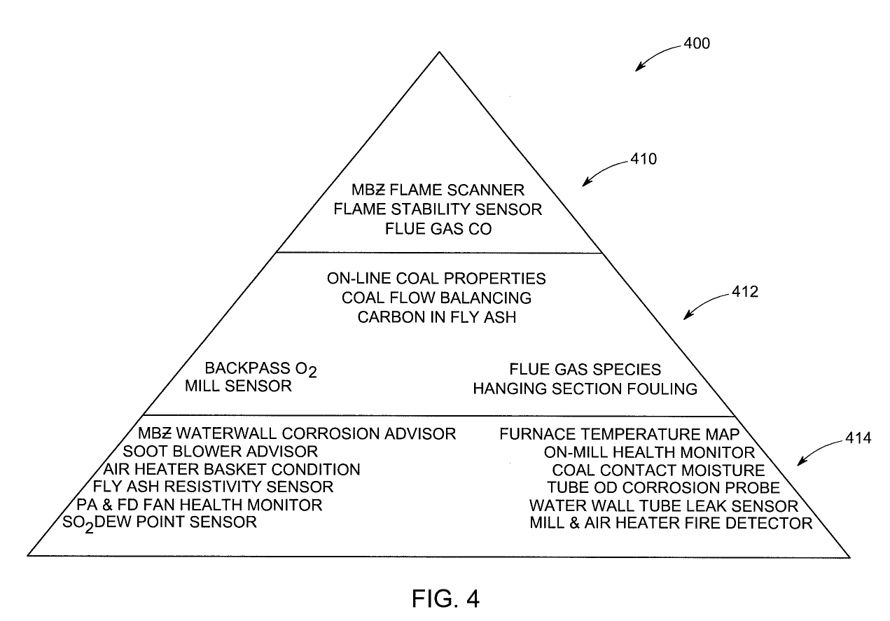

With reference to FIG. 4, in an embodiment, a sensor priority chart 400 according to an embodiment of the invention is illustrated. In an embodiment, the control unit 100 may be programmed to prioritize the sensor feedbacks to keep monitored operation parameters within prescribed thresholds according to the chart 400. For example, as illustrated therein, keeping oxygen levels, as measured by sensor 44 will not take precedence over keeping carbon monoxide levels, as measured by monitoring device 40. As shown therein, this hierarchal control may be grouped into three or more priority levels, for example, a highest priority level 410, a medium priority level 412 and a lowest priority level 414.

As discussed above, the combustion system and control unit therefor continually seeks the lowest possible excess air conditions to maximize system efficiency (i.e., achieves total air reduction), while at the same time maintaining optimum main burner zone stoichiometry to minimize emissions and honoring a multitude of real-time operating process constraints require to preserve operation and safety (i.e., individual air balancing). In particular, the control unit is configured to individually control the amount of air provided to each air introduction location to continuously optimize the level excess air for the combustion process in real-time on a continuous operating basis. By monitoring so many operational parameters and by controlling combustion at the individual burner level, low excess air operation and target power outputs can be achieved for any particular type of fuel utilized (or variations within fuels), and at all loads and shifts.

The combustion system and control therefor provided by the invention provide financial, emissions and operational benefits. In particular, fuel savings and emissions reductions can be achieved by optimizing the stoichiometric ratio at the local burner level and minimizing excess air. The combustion system provides for main burner zone emissions control by precisely controlling combustion at the individual burner level. For example, significant savings may be realized for each boiler in operation even where excess air level is simply reduced 5% from a nominal 15%-20% which is common in the industry. These cost savings can be achieved as a result of the lower amount of product gas that directly results from lower excess air operation. The lower gas flow reduces the amount of auxiliary power that is needed to operate the downstream equipment, including fans and pumps for the required air quality control equipment. The reduction in auxiliary power translates into the need for less fuel and steam to achieve a given production level which, in turn, further reduces the fuel requirements and increases efficiency.

Emissions reductions for the conventional air pollutants stem from the lower fuel requirements. In addition, lower excess air results in lower NOₓ formation and lower SO₃ formation. Lower NOₓ emissions further reduce the need for additives, such as ammonia, to reduce the NOₓ in downstream equipment. Similarly, lower SO₃ levels reduce the amount of corrosion experienced by the downstream equipment.

In addition to operational savings, the combustion system of the invention provides for capital cost savings on new plant or boiler design and constructions. In particular, with the control system disclosed herein, it is possible to design plan equipment for lower excess air levels from the start.

While the combustion system of the invention allows for the real-time monitoring of numerous operational parameters that are utilized by a controller to more precisely control the combustion process and to continuously drive excess air to a minimum to maximize system efficiency, the invention is not so limited in this regard. In particular, the various sensor feedbacks, in addition to being used in real-time combustion process control, can be stored and compiled for use in diagnostic and predictive analytics for asset performance and maintenance assessments of the process and equipment. That is, the data obtained from the various sensors and measurement devices can be stored or transmitted to a central controller or the like so that equipment and process performance can be assessed and analyzed. For example, the sensor feedbacks can be utilized to assess equipment health, for use in scheduling maintenance, repairs and/or replacement.

In an embodiment, a combustion system is provided. The combustion system includes a combustion chamber, a plurality of fuel introduction locations in the combustion chamber where fuel and air are provided to the combustion chamber for combustion, a fluid flow control device associated with each fuel introduction location, each fluid flow control device being controllable to vary an amount of the air supplied to each fuel introduction location, a plurality of sensing devices configured to monitor a plurality of operational parameters of the combustion system, and a control unit configured to control each fluid flow control device to control the amount of air supplied at each fuel introduction location independent of the amount of air supplied at the other fuel introduction locations, and to control the amount of air provided to all other air introduction locations, in dependence upon at least one of the plurality of operational parameters to minimize excess air provided to the combustion chamber.

In an embodiment, the plurality of sensing devices include at least one flame scanning device in communication with the control unit, the at least one flame scanning device being configured to determine a stoichiometric ratio of the fuel and the air at each fuel introduction location. The at least one operational parameter is the stoichiometric ratio at each fuel introduction location. In an embodiment, the plurality of operational parameters include at least one of an air/fuel ratio at each fuel introduction location, a flame temperature, fireball stability, flue gas temperature, flue gas species, an amount of unburnt carbon in fly ash, an oxygen concentration in a flue gas, pressure drop, opacity, and a combustion chamber wall condition. In an embodiment, the at least one operational parameter is an air/fuel ratio associated with each fuel introduction location. In an embodiment, the at least one operational parameter includes the amount of unburnt carbon in the fly ash. In an embodiment, the control unit is configured to control at least one of the fluid flow control devices to increase the amount of the air provided to at least one of the fuel introduction locations if the amount of unburnt carbon in the fly ash exceeds a threshold level. In an embodiment, the plurality of sensing devices include at least: a flame scanning device configured to determine the an air/fuel ratio at each fuel introduction location, a flame stability monitor for assessing fireball stability, a temperature mapping device for mapping a flue gas temperature at a cross-section of a flue gas passageway of the combustion system, an optical monitoring device for measuring and assessing a plurality of gas species in the flue gas, a sensing device for measuring the amount of unburnt carbon in the fly ash, and an opacity monitoring device to measure an amount of particulates in the flue gas exiting a stack of the combustion system. In an embodiment, each fuel introduction location of the plurality of fuel introduction locations includes a burner assembly. In an embodiment, the combustion system may also include a pulverizer in fluid communication with each of the fuel introduction locations for supplying pulverized coal to each of the fuel introduction locations.

In another embodiment, a method of controlling a combustion system is provided. The method includes the steps of introducing fuel and air to a combustion chamber at a plurality of fuel introduction locations, monitoring a plurality of operational parameters of the combustion system, and minimizing an amount of excess air provided to the combustion chamber by individually controlling an amount of air supplied to the combustion chamber at each of the fuel introduction locations in dependence upon at least one of the plurality of operational parameters. In an embodiment, the step of monitoring the plurality of operational parameters includes determining a stoichiometric ratio of air and fuel at each of the fuel introduction locations, wherein the at least one operational parameter is the stoichiometric ratio of air and fuel at each of the fuel introduction locations. In an embodiment, the plurality of operational parameters include at least an air/fuel ratio at each fuel introduction location and at least one of a flame temperature, fireball stability, flue gas temperature, flue gas species, an amount of unburnt carbon in fly ash, an oxygen concentration in a flue gas, pressure drop, opacity, and a combustion chamber wall condition. In an embodiment, the plurality of operational parameters include at least the amount of unburnt carbon in the fly ash. In an embodiment, the method may also include the step of increasing an amount of air provided to at least one of the fuel introduction locations if the amount of unburnt carbon in the fly ash exceeds a threshold level. In the combustion system includes at least a flame scanning device configured to determine the an air/fuel ratio at each fuel introduction location, a flame stability monitor for assessing fireball stability, a temperature mapping device for mapping a flue gas temperature at a cross-section of a flue gas passageway of the combustion system, an optical monitoring device for measuring and assessing a plurality of gas species in the flue gas, a sensing device for measuring the amount of unburnt carbon in the fly ash, and an opacity monitoring device to measure an amount of particulates in the flue gas exiting a stack of the combustion system. In an embodiment, the method may include pulverizing coal in a pulverizer, supplying the pulverized coal to each of the fuel introduction locations.

In yet another embodiment, a boiler is provided. The boiler includes a combustion chamber, a plurality of fuel introduction locations in the combustion chamber for introducing fuel to the combustion chamber for combustion, a plurality of fluid flow control devices, each fluid flow control device being controllable to vary an amount of air supplied to the boiler, a plurality of sensing devices configured to monitor a plurality of operational parameters of the combustion system, and a control unit configured to control the amount of the air supplied to the boiler in dependence upon at least one of the plurality of operational parameters to continuously optimize an amount of excess air provided to the combustion chamber. In an embodiment, the plurality of sensing devices include at least one flame scanning device in communication with the control unit, the at least one flame scanning device being configured to determine a stoichiometric ratio of the fuel and the air at each fuel introduction location. The at least one operational parameter may be the stoichiometric ratio at each fuel introduction location. In an embodiment, the plurality of operational parameters include at least one of an air/fuel ratio at each fuel introduction location, a flame temperature, fireball stability, flue gas temperature, flue gas species, an amount of unburnt carbon in fly ash, an oxygen concentration in a flue gas, pressure drop, opacity, and a combustion chamber wall condition. In an embodiment, the plurality of sensing devices include at least a flame scanning device configured to determine the air/fuel ratio at each fuel introduction location, a flame stability monitor for assessing fireball stability, a temperature mapping device for mapping a flue gas temperature at a cross-section of a flue gas passageway of the boiler, an optical monitoring device for measuring and assessing a plurality of gas species in the flue gas, a sensing device for measuring an amount of unburnt carbon in fly ash, and an opacity monitoring device to measure an amount of particulate in the flue gas exiting a stack of the boiler.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A combustion system, comprising:
a combustion chamber;
a plurality of fuel introduction locations in the combustion chamber where fuel and air are provided to the combustion chamber for combustion;
a fluid flow control device associated with each fuel introduction location, each fluid flow control device being controllable to vary an amount of the air supplied to each fuel introduction location;
a plurality of sensing devices configured to monitor a plurality of operational parameters of the combustion system; and
a control unit configured to control each fluid flow control device to control the amount of air supplied at each fuel introduction location independent of the amount of air supplied at the other fuel introduction locations, and to control the amount of air provided to all other air introduction locations, in dependence upon at least one of the plurality of operational parameters to minimize excess air provided to the combustion chamber.

2. The combustion system of claim 1, wherein:
the plurality of sensing devices include at least one flame scanning device in communication with the control unit, the at least one flame scanning device being configured to determine a stoichiometric ratio of the fuel and the air at each fuel introduction location; and
wherein the at least one operational parameter is the stoichiometric ratio at each fuel introduction location.

3. The combustion system of claim 1, wherein:
the plurality of operational parameters include at least one of an air to fuel ratio at each fuel introduction location, a flame temperature, fireball stability, flue gas temperature, flue gas species, an amount of unburnt carbon in fly ash, an oxygen concentration in a flue gas, carbon in fly ash, pressure drop, opacity, and a combustion chamber wall condition.

4. The combustion system of claim 3, wherein:
the at least one operational parameter is an air to fuel ratio associated with each fuel introduction location.

5. The combustion system of claim 3, wherein:
the at least one operational parameter includes the amount of unburnt carbon in the fly ash.

6. The combustion system of 5, wherein:
the control unit is configured to control at least one of the fluid flow control devices to increase the amount of the air provided to at least one of the fuel introduction locations:
if the amount of unburnt carbon in the fly ash exceeds a threshold level;
if the amount of carbon dioxide in a flue gas exceeds a threshold level; or if the fireball stability is outside of a threshold range.

7. The combustion system of claim 3, wherein:
the plurality of sensing devices include at least:
a flame scanning device configured to determine the an air to fuel ratio at each fuel introduction location;
a flame stability monitor for assessing fireball stability;
a temperature mapping device for mapping a flue gas temperature at a cross-section of a flue gas passageway of the combustion system;
an optical monitoring device for measuring and assessing a plurality of gas species in the flue gas;
a sensing device for measuring the amount of unburnt carbon in the fly ash;
an opacity monitoring device to measure an amount of particulates in the flue gas exiting a stack of the combustion system;
a paramagnetic sensor for monitoring an amount of oxygen in the flue gas; and
a coal analyzer.

8. The combustion system of claim 1, wherein:
each fuel introduction location of the plurality of fuel introduction locations includes a burner assembly.

9. The combustion system of claim 1, further comprising:
a pulverizer in fluid communication with each of the fuel introduction locations for supplying pulverized coal to each of the fuel introduction locations.

10. The combustion system of claim 1, wherein:
the combustion chamber is part of one of a T-fired boiler, a wall fired boiler, a circulating fluidized bed (CFB) boiler, a bubbling fluidized bed (BFB) boiler, a stoker boiler, a suspension burner for biomass boilers, a dutch oven, a hybrid suspension grate boiler, a fire tube boiler, a kiln, an incinerator, a fired heater and a glass furnace

11. A method of controlling a combustion system, comprising the steps of:
introducing fuel and air to a combustion chamber at a plurality of fuel introduction locations;
monitoring a plurality of operational parameters of the combustion system; and
minimizing an amount of excess air provided to the combustion chamber by individually controlling an amount of air supplied to the combustion chamber at each of the fuel introduction locations in dependence upon at least one of the plurality of operational parameters.

12. The method according to claim 11, wherein:
the step of monitoring the plurality of operational parameters includes determining a stoichiometric ratio of air and fuel at each of the fuel introduction locations; and
wherein the at least one operational parameter is the stoichiometric ratio of air and fuel at each of the fuel introduction locations.

13. The method according to claim 11, wherein:
the plurality of operational parameters include at least an air to fuel ratio at each fuel introduction location and at least one of a flame temperature, fireball stability, flue gas temperature, flue gas species, an amount of unburnt carbon in fly ash, an oxygen concentration in a flue gas, pressure drop, opacity, and a combustion chamber wall condition.

14. The method according to claim 13, wherein:
the plurality of operational parameters include at least the amount of unburnt carbon in the fly ash.

15. The method according to claim 14, further comprising the step of:
increasing an amount of air provided to at least one of the fuel introduction locations if the amount of unburnt carbon in the fly ash exceeds a threshold level.

16. The method according to claim 13, wherein:
the combustion system includes at least:
a flame scanning device configured to determine the an air to fuel ratio at each fuel introduction location;
a flame stability monitor for assessing fireball stability;
a temperature mapping device for mapping a flue gas temperature at a cross-section of a flue gas passageway of the combustion system;
an optical monitoring device for measuring and assessing a plurality of gas species in the flue gas;
a sensing device for measuring the amount of unburnt carbon in the fly ash;
an opacity monitoring device to measure an amount of particulates in the flue gas exiting a stack of the combustion system;
a paramagnetic sensor for monitoring an amount of oxygen in the flue gas; and
a coal analyzer.

17. The method according to claim 11, further comprising the step of:
pulverizing coal in a pulverizer; and
supplying the pulverized coal to each of the fuel introduction locations.

18. A boiler comprising:
a combustion chamber;
a plurality of fuel introduction locations in the combustion chamber for introducing fuel to the combustion chamber for combustion;
a plurality of fluid flow control devices, each fluid flow control device being controllable to vary an amount of air supplied to the boiler;
a plurality of sensing devices configured to monitor a plurality of operational parameters of the combustion system; and
a control unit configured to control the amount of the air supplied to the boiler in dependence upon at least one of the plurality of operational parameters to continuously optimize an amount of excess air provided to the combustion chamber.

19. The boiler of claim 18, wherein:
the plurality of sensing devices include at least one flame scanning device in communication with the control unit, the at least one flame scanning device being configured to determine a stoichiometric ratio of the fuel and the air at each fuel introduction location; and
wherein the at least one operational parameter is the stoichiometric ratio at each fuel introduction location.

20. The boiler of claim 18, wherein:
the plurality of operational parameters include at least one of an air to fuel ratio at each fuel introduction location, a flame temperature, fireball stability, flue gas temperature, flue gas species, an amount of unburnt carbon in fly ash, an oxygen concentration in a flue gas, carbon in fly ash, pressure drop, opacity, and a combustion chamber wall condition.
